(19) United States
(12) Patent Application Publication
(10) Pub. No.: US 2021/0031426 A1
(43) Pub. Date: Feb. 4, 2021

(54) TEMPERATURE CONTROL DEVICE OF INJECTION MOLDING MACHINE HAVING ABNORMALITY DETECTION FUNCTION

(71) Applicant: FANUC CORPORATION, Yamanashi (JP)

(72) Inventor: Junpei MARUYAMA, Yamanashi (JP)

(73) Assignee: FANUC CORPORATION, Yamanashi (JP)

(21) Appl. No.: 16/906,968

(22) Filed: Jun. 19, 2020

(30) Foreign Application Priority Data
Jul. 29, 2019 (JP) 2019-138575

(51) Int. Cl. B29C 45/78; B29C 45/73; B29C 45/77

(52) U.S. Cl. CPC B29C 45/78; B29C 45/77; B29C 45/73

(57) ABSTRACT

An injection molding temperature control device according to an aspect of the present disclosure controls output of a heater that heats a target site, based on a detection value of a temperature sensor which detects temperature of the target site of an injection molding machine that injects resin into a mold using an injection machine, the injection molding temperature control device including: a temperature control unit which controls output of the heater so as to make the detection value of the temperature sensor approach a predetermined set temperature; a supplied heat amount calculation unit which calculates a supplied heat amount to the target site based on at least one of a drive voltage, a duty ratio and an electrical current value of the heater; and an abnormality detection unit which detects abnormality in temperature control of the target site, based on the detection value of the temperature sensor, and a supplied heat amount calculated by the supplied heat amount calculation unit.

This application is based on and claims the benefit of priority from Japanese Patent Application No. 2019-138575, filed on 29 Jul. 2019, the content of which is incorporated herein by reference.

### BACKGROUND OF THE INVENTION

### Field of the Invention

The present invention relates to a temperature control device of an injection molding machine having an abnormality detection function.

### Related Art

Injection molding machines which produce a resin molded article by injecting molten resin into a mold are widely used. In the injection molding machine, a heater and temperature sensor are provided to each target site of the cylinder of the injection machine and mold, and the output of the heater is controlled so as to make the detection value of the temperature sensor approach a set temperature.

In the injection molding machine, for example, in the case of the heater being separate from a target site, heat is not transmitted to the target site even if increasing the output of the heater, and the detection value of the temperature sensor also does not rise. For this reason, when the heater is separate from the target site, the output of the heater abnormally increases, and there is risk of the heater being damaged due to overheating.

In addition, in the case of the temperature sensor being separate from the target site, since the detection value of the temperature sensor remains low irrespective of the temperature of the target site rising, there is a risk of the output of the heater becoming abnormally high, and leading to a quality decline or the like of the resin molded article.

As a means for detecting an abnormality of a configuration related to temperature control of such an injection molding machine, Patent Document 1 discloses an injection molding temperature control device (controller) possessing “a control part which measures a working time of the temperature control part, detects the temperature of a controlled body when the working time has reached a specified time, via the temperature detector, and judges as being abnormal in a case of the detected temperature not reaching a specified temperature”.

Patent Document 1: Japanese Unexamined Patent Application, Publication No. H05-177686

### SUMMARY OF THE INVENTION

A change in temperature relative to the working time of the heater will not be fixed according to changes in internal and external conditions such as the material temperature and environmental temperature, for example; therefore, it is not necessarily possible to accurately detect abnormality of temperature control simply based on the relationship between the working time and temperature as disclosed in Patent Document 1. For this reason, an injection molding temperature control device which can relatively accurately detect abnormality in temperature control has been desired.

An injection molding temperature control device according to an aspect of the present disclosure controls output of a heater that heats a target site, based on a detection value of a temperature sensor which detects temperature of the target site of an injection molding machine that injects resin into a mold using an injection machine, the injection molding temperature control device including: a temperature control unit which controls output of the heater so as to make the detection value of the temperature sensor approach a predetermined set temperature; a supplied heat amount calculation unit which calculates a supplied heat amount to the target site based on at least one of a drive voltage, a duty ratio and an electrical current value of the heater; and an abnormality detection unit which detects abnormality in temperature control of the target site, based on the detection value of the temperature sensor, and a supplied heat amount calculated by the supplied heat amount calculation unit.

An injection molding temperature control device according to the aspect of the present disclosure can relatively accurately detect abnormality in temperature control.

### BRIEF DESCRIPTION OF THE DRAWINGS

FIG. 1 is a schematic diagram showing the configuration of an injection molding system equipped with an injection molding temperature control device according to an embodiment of the present disclosure;

FIG. 2 is a block diagram showing abnormality detection in the injection molding temperature control device of FIG. 1;

FIG. 3 is a graph showing the temperature change during startup of a normal injection molding system;

FIG. 4 is a graph showing the temperature change during startup of an injection molding system in which the heater is separate;

FIG. 5 is a graph showing the temperature change during steady operation of a normal injection molding system; and

FIG. 6 is a graph showing the temperature change in a case of the heater being separated during steady operation of the injection molding system.

### DETAILED DESCRIPTION OF THE INVENTION

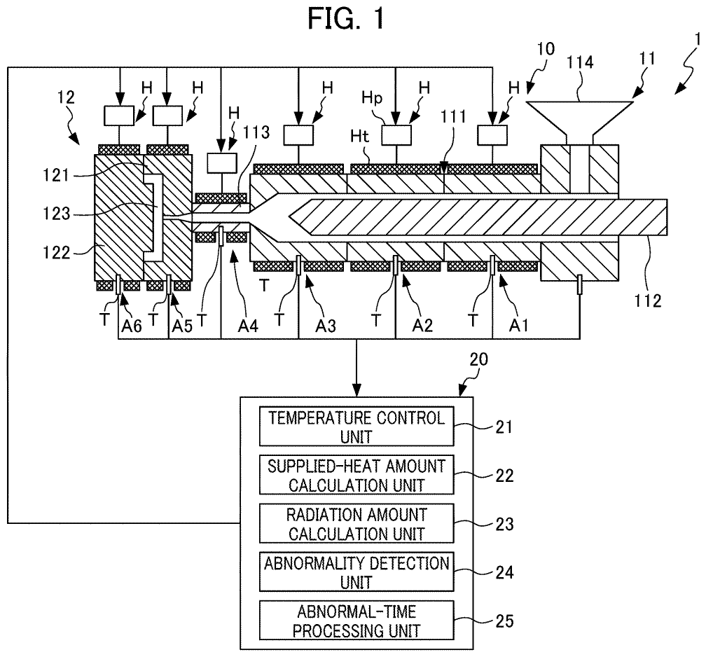

Hereinafter, an embodiment of the present disclosure will be explained while referencing the drawings. FIG. 1 is a schematic diagram showing the configuration of an injection molding system 1 equipped with an injection molding temperature control device according to an embodiment of the present disclosure. The injection molding system 1 includes an injection molding machine 10 and an injection molding temperature control device 20.

The injection molding machine 10 includes an injection machine 11 and a mold 12. The injection molding machine 10 produces a resin molded article by injection into the mold 12 using an injection machine 11.

The injection machine 11 includes: a cylinder 111, a screw 112 arranged to be rotatable inside the cylinder 111, a nozzle 113 provided to a leading end (downstream side end) of the cylinder 111, and a feed hopper 114 which supplies resin to the base end (upstream most part) of the cylinder 111. The injection machine 11 injects resin from the nozzle 113 by causing to move from the base end side to the leading end side by rotation of the screw 112.

The cylinder 111 has a plurality of target sites A1, A2, A3 at which temperature sensors T and heaters H are respectively arranged, and which are temperature controlled independently. In addition, the cylinder 111 is not a target site which is temperature controlled and a heater being arranged thereto; however, the temperature sensor T is provided also to a site most to the base end side. In addition, the nozzle 113 is defined as target site A4 which is one to which the temperature sensor T and heater H are arranged, and is temperature controlled.

The mold 12 is divided into a fixed mold 121 and a mobile mold 122, and forms therebetween a cavity 123 to which resin is injected by the injection machine 11. The fixed mold 121 and mobile mold 122 are defined as target sites A5, A6 to which the temperature sensors T and heaters H are respectively arranged, and independently temperature controlled.

The temperature sensors T are sufficient so long as able to detect the temperature of the target sites A1 to A6, and can be established as a configuration having a thermocouple or the like, for example. The heaters H are sufficient so long as able to heat the target sites A1 to A6 and, for example, can be established as a configuration mounted to the target site, and having a heating element H1 which heats by way of electric conduction, and an amplifier Hp which supplies electrical power to the heating element Ht.

The injection molding temperature control device 20 controls the output of the heater H based on the detection value of the temperature sensor T at every target site A1 to A6. The injection molding temperature control device 20, for example, can be realized by causing the appropriate control program to be executed in a computer device equipped with a CPU, memory, a signal interface for connecting with the temperature sensor T and heater H, etc.

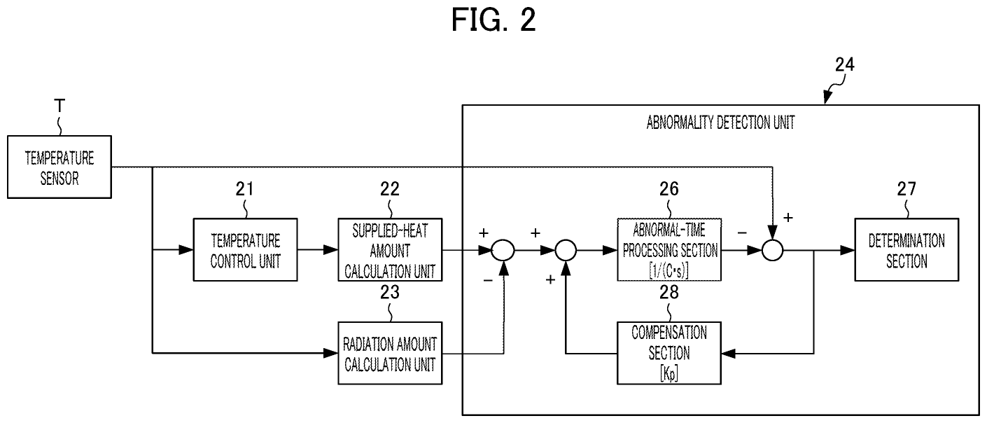

The injection molding temperature control device 20, as shown in detail by FIG. 2, includes a temperature control unit 21, a heat supplied amount calculation unit 22, a radiation amount calculation unit 23, an abnormality detection unit 24 and an abnormal-time processing unit 25. These constituent elements are distinguished from each other in the functions thereof, and may not necessarily be clearly distinguishable in the physical configuration and program configuration. In addition, the injection molding temperature control device 20 is configured so as to be able to perform the control of FIG. 2 in parallel by time-sharing processing, for example, by the number of target sites A1 to A6.

The temperature control unit 21 controls the output of the heater H so as to make the detection value of the temperature sensor T approach a predetermined set temperature. As the control method by the temperature control unit 21, it is possible to adopt known feedback control such as PID control, ON-OFF control, or the like.

The supplied-heat amount calculation unit 22 calculates the respective supplied heat amounts to the target sites A1 to A6, based on at least one of the drive voltage of the heater H (output voltage of the amplifier Hp), duty ratio of the heater H, and electrical current value of the heater H. In other words, the supplied-heat amount calculation unit 22 calculates the supplied heat amount to the target sites A1 to A6, with the power value inputted to the heater H as the heat amount of the heater H. The temperature changes of the target sates A1 to A6 depend on the supplied heat amount; therefore, by calculating the supplied heat amounts to the target sites A1 to A6, it becomes possible to accurately detect abnormality in temperature control by estimating the temperature change of the target sites A1 to A6 in the abnormality detection unit 24 described later.

The supplied-heat amount calculation unit 22 may calculate the supplied heat amount to the target sites A1 to A6 considering the flow rate of resin flowing in from the upstream side. In other words, the supplied-heat amount calculation unit 22 may calculate the supplied heat amount to the target sites A1 to A6, by deducting the heat amount absorbed by the resin having low temperature flowing in from the upstream side, from the heating amount of the heater H. In addition, in the case of higher temperature resin being supplied from the upstream side to the target sites A1 to A6, the supplied-heat amount calculation unit 22 can add the heat supplied from this resin to the heating amount of the heater H to calculate the supplied heat amount to the target sites A1 to A6.

More specifically, it is possible to calculate the heat amount absorbed by the resin or heat amount supplied, by multiplying the difference between the detection value of the temperature sensor T of the target site A1 to A6 and the detection value of the temperature sensor T of a site adjacent on the upstream side, the flow rate of resin, and the specific heat of the resin. In this way, it is possible to more accurately determine abnormality of the temperature control in the abnormality detection unit 24, by considering the flow rate of resin. It should be noted that, in the case of the heat amount absorbed or heat amount supplied to the resin flowing in being sufficiently smaller compared to the heating amount of the heater H, the error is sufficiently small even when ignoring this heat amount.

The radiation amount calculation unit 23 calculates the radiation amount to outside from the target sites A1 to A6, based on the detection value of the temperature sensor T, at every target site A1 to A6. By using the calculated radiation amount, it is possible to detect abnormality of temperature control more accurately in the abnormality detection unit 24.

The radiation amount calculation unit 23 may calculate the radiation amount by further considering the flow rate of resin, i.e. the flow rate of resin injected to the mold 12 from the injection machine 11 (for example, volumetric flow rate which can be calculated from the rotation speed of the screw 112). Since it is thereby possible to more accurately estimate the temperature change of target sites A1 to A6 in the abnormality detection unit 24, it becomes possible to accurately detect abnormality of the temperature control.

The abnormality detection unit 24 detects abnormality of the constituent elements related to temperature control of the target sites A1 to A6, based on the detection value of the temperature sensor T, the supplied heat amount calculated by the supplied-heat amount calculation unit 22, and the radiation amount calculated by the radiation amount calculation unit 23. The abnormality detection unit 24 includes: an estimation section 26 which estimates the temperature of the target sites A1 to A6, a determination section 27 which determines abnormality of the temperature control based on the detection value of the temperature sensor T and the estimation value of the estimation section 26, and a compensation section 28 which compensates the heat amount used for calculation by the estimation section 26.

The estimation section 26 estimates the temperature of the target sites A1 to A6, based on the heat amount deducting the radiation amount calculated by the radiation amount calculation unit 23 from the supplied heat amount calculated by the supplied-heat amount calculation unit 22, i.e. change amount in heat amount inside of the target sites A1 to A6. In more detail, the estimation section 26 can calculate the temperature change amount of the target sites A1 to A6 as a value arrived as by dividing the integrated value of the difference between the supplied heat amount and radiation amount to the target sites A1 to A6, by the heat capacity C of the target sites A1 to A6. When defining the supplied heat amount as Wh and the radiation amount as Wr, the relationship with the temperature change amount ΔT is represented as C·ΔT=ƒ(Wh−Wr)dt.

In order to obtain the estimated value for the current temperature of the target sites A1 to A6, it is necessary to add the temperature change amount to the initial temperature; however, the detection value of the temperature sensor T during control start or measured value of the ambient temperature may be set as the initial temperature, or a fixed value within the normal initial temperature range may be set as the initial temperature. In the case of the estimation section 26 using degrees centigrade, the initial temperature may be considered as 0° C. and addition of the initial temperature may be omitted.

The determination section 27 determines abnormality of the temperature control in a case of the difference between the detection value of the temperature sensor T and the estimated value of the estimation section 26 exceeding a predetermined abnormality threshold. In other words, in a case of the current temperature or the target sites A1 to A6 estimated from the heat amount supplied to the target sites A1 to A6 being excessively higher than the current detection value of the temperature sensor T, it can be determined that the temperature sensor T cannot correctly measure the temperature of target sites A1 to A6, or that the heater H cannot appropriately heat the target sites A1 to A6.

The compensation section 28 compensates the heat amount (value arrived at by subtracting the radiation amount from the supplied heat amount) used in computation by the estimation section 26, so that the difference between the detection value of the temperature sensor T and the estimated value of the estimation section 26 becomes small. More specifically, the compensation section 28 adds the value arrived at by multiplying a predetermined compensation factor Kp by the difference between the detection value of the temperature sensor T and the estimated value of the estimation section 26, to the heat amount inputted to the estimation section 26. It is thereby possible to compensate the difference between the initial temperature used by the estimation section 26 and the actual temperature of the target sites A1 to A6 during control start, and can prevent the difference between the estimated value and detection value from increasing irrespective of there being no abnormality in the configuration related to the temperature control by accumulation of error contained in the calculated values of supplied heat amount and radiation amount. It should be noted that, if excessively increasing the correction factor Kp, since there is a risk of the deviation between the estimated value and detection value in the case of abnormality occurring in the configuration related to temperature control also offsetting, it is desired to set the value of a minimum limit.

The abnormal-time processing unit 25, when the abnormality detection unit detects abnormality in the temperature control, performs at least either of abnormality notification and output stop of the heater H. It is thereby possible to prevent the heater H and target sites A1 to A6 from being damaged due to heat, and suppresses an injection molded article of low quality from being produced by operating the injection molding system at inappropriate temperature conditions.

Next, the tame change of the temperature of the heater H (heating element Ht) of the injection molding system 1, temperature of the target site A1 (detection value of temperature sensor T) and heating amount of heater H will be specifically explained.

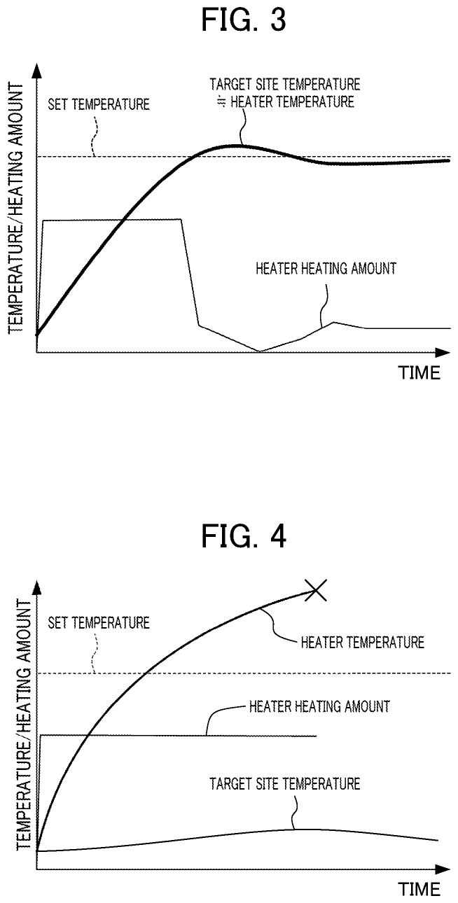

FIG. 3 illustrates the change of each value during startup of the injection molding system 1 in which the configurations related to temperature control are all normal, i.e. upon raising the temperature of each target site A1 to A6 from room temperature up to a producible set temperature. In this example, the detection value of the temperature sensor T matches the temperature of the target site A1. As shown, the output of the heater H becomes the maximum output during startup, declines when the detection value of the temperature sensor T increases a certain extent, and subsequently, fluctuates within a small range so as to keep the detection value of the temperature sensor T at the set temperature.

FIG. 4 illustrates the change of each value during startup of the injection molding system 1 in which the heater H is not attached to the target site A1. In this example, since heat is not transmitted from the heater H to the target site A1, only the heater H rises in temperature, and the target site A1 only slightly rises in temperature due to heat conduction, etc. from the adjacent target site A2. In this case, the heat H becomes extremely high temperature, and if left alone, there is risk of the heater H and constituent elements in the surrounding being damaged.

However, with the injection molding system 1, the injection molding temperature control device 20, due to detecting abnormality of temperature control by confirming the deviation between the heating amount of the heater H and the temperature rise of the target site A1, the interruption of heating by the heater H or handling by the operator is done prior to the heater H, etc. being damaged.

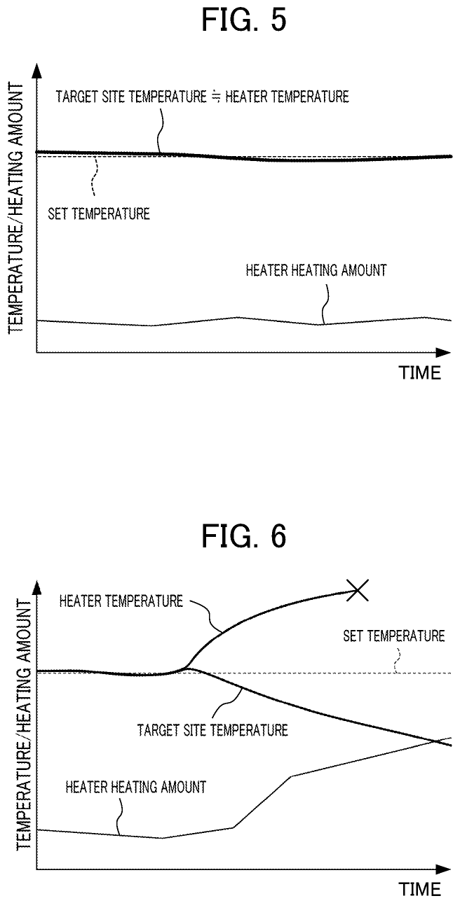

FIG. 5 illustrates the change of each value during normal operating of the injection molding system 1 in which the configurations related to temperature control are all normal. In this example, the output of the heater H fluctuates within a small range, and the temperature of the target site A1 and the detection value of the temperature sensor T matching this are maintained at approximately the set temperature.

FIG. 6 illustrates the change of each value in the case of the heater H uncoupling from the target site A1 during normal operating. When the heater H uncouples from the target site A1, the temperature of the heater H which no longer can dissipate heat to the target site A rises, while the temperature of the target site A1 to which heat is not supplied from the heater H gradually declines.

In this case as well, the heater H becomes very high temperature, and if left alone, there is a risk of the heater H and constituent elements in the surroundings being damaged; however, by detecting abnormality of the temperature control, it is possible to perform interruption of heating by the heater H or handling by the operator before the heater H, etc. is damaged.

In the above way, the injection molding temperature control device 20 can relatively accurately detect abnormality of the configuration related to temperature control of the injection molding machine 10; therefore, it is possible to prevent damage of the injection molding temperature control device 20.

Although an embodiment of the present disclosure has been explained above, the present invention is not to be limited to the aforementioned embodiment. In addition, the effects described in the present embodiment are merely listing the most favorable effects produced from the present invention, and the effects from the present invention are not to be limited to those described in the present embodiment.

The injection molding temperature control device according to the present disclosure may control the temperature of a single control target.

In the injection molding temperature control device according to the present disclosure, the radiation amount calculation unit may calculate the radiation amount to outside from the target site based on the supplied heat amount calculated by the supplied-heat amount calculation unit, or may calculate the radiation amount to outside from the target site based on both the detection value of the temperature sensor and the radiation amount calculated by the supplied-heat amount calculation unit.

In the injection molding temperature control device according to the present disclosure, the radiation amount calculation unit can be omitted. Normally, the radiation amount is sufficiently small compared to the heating amount of the heater; therefore, the error is small even if ignoring the radiation amount. In addition, in the case of the abnormality detection unit having a correction unit, the correction unit can generate an offset to handle the radiation amount.

In the injection molding temperature control device according to the present disclosure, the abnormality detection unit may be configured so as to detect abnormality of temperature control according to the behavior of the detection value of the temperature sensor and the supplied heat amount, without estimating the temperature of the target site.

In the injection molding temperature control device according to the present disclosure, the compensation section can be omitted.

### EXPLANATION OF REFERENCE NUMERALS

1 injection molding system
10 injection molding machine
11 injection machine
12 mold
20 injection molding temperature control device
21 temperature control unit
22 supplied heat amount calculation unit
23 radiation amount calculation unit
24 abnormality detection unit
25 abnormal-time processing unit
26 estimation section
27 determination section
26 compensation section
T temperature sensor
H heater

What is claimed is:

1. An injection molding temperature control device which controls output of a heater that heats a target site, based on a detection value of a temperature sensor which detects temperature of the target site of an injection molding machine that injects resin into a mold using an injection machine, the injection molding temperature control device comprising:
a temperature control unit which controls output of the heater so as to make the detection value of the temperature sensor approach a predetermined set temperature;
a supplied heat amount calculation unit which calculates a supplied heat amount to the target site based on at least one of a drive voltage, a duty ratio and an electrical current value of the heater; and
an abnormality detection unit which detects abnormality in temperature control of the target site, based on the detection value of the temperature sensor, and a supplied heat amount calculated by the supplied heat amount calculation unit.

2. The injection molding temperature control device according to claim 1,
wherein the abnormality detection unit includes:
an estimation section which estimates a temperature of the target site based on the supplied heat amount calculated by the supplied heat amount calculation unit; and
a determination section which determines abnormality in the temperature control in a case of a difference between the detection value of the temperature sensor and an estimated value of the estimation section exceeding a predetermined abnormality threshold.

3. The injection molding temperature control device according to claim 2, wherein the abnormality detection unit further includes a compensation section that compensates a heat amount used in computation by the estimation section, so that the difference between the detection value of the temperature sensor and the estimated value of the estimation section becomes smaller.

4. The injection molding temperature control device according to claim 1, further comprising a radiation amount calculation unit that calculates a radiation amount from the target site to outside, based on at least any of the detection value of the temperature sensor and the supplied heat amount calculated by the supplied heat amount calculation unit,
wherein the abnormality detection unit detects abnormality in temperature control, based on the detection value of the temperature sensor, the supplied heat amount calculated by the supplied heat amount calculation unit, and a radiation amount calculated by a radiation amount calculation unit.

5. The injection molding temperature control device according to claim 4, wherein the radiation amount calculation unit calculates the radiation amount by further taking consideration of a flow rate of the resin.

6. The injection molding temperature control device according to claim 1, wherein the supplied heat amount calculation unit calculates the supplied heat amount to the target site by considering a flow rate of the resin which flows in from an upstream side.

7. The injection molding temperature control device according to claim 1, further comprising an abnormal-time processing unit which performs at least any of notification of the abnormality and output stop of the heater, when the abnormality detection unit has detected abnormality in temperature control.
